(19) United States
(12) Patent Application Publication
(10) Pub. No.: US 2019/0288397 A1
(43) Pub. Date: Sep. 19, 2019

(54) MICROSTRIP ANTENNA, ANTENNA ARRAY AND METHOD OF MANUFACTURING MICROSTRIP ANTENNA

(71) Applicant: Alcatel Lucent, Nozay (FR)

(72) Inventors: Fei Gao, Shanghai (CN); Jinxing Lu, Shanghai (CN); Wei Wang, Shanghai (CN); Gang Shen, Shanghai (CN)

(73) Assignee: Alcatel Lucent, Nozay (FR)

(21) Appl. No.: 16/317,624

(22) PCT Filed: Jul. 12, 2017
(86) PCT No.: PCT/IB2017/001068

§ 371 Date: Jan. 14, 2019

(30) Foreign Application Priority Data
Jul. 14, 2016 (CN) 201610554499.X

(51) Int. Cl. H01Q 9/04; H01Q 5/357; H01Q 21/28

(52) U.S. Cl. CPC H01Q 9/0421; H01Q 9/0442; H01Q 21/28; H01Q 5/357

(57) ABSTRACT

Embodiments of the present disclosure provide a microstrip antenna and an antenna array. The microstrip antenna includes a ground plane disposed on a first surface of a substrate of the microstrip antenna; a metal patch disposed on a second surface of the substrate opposite to the first surface; a feeding point disposed on the metal patch such that the microstrip antenna has a first resonant frequency; and a shorting point disposed on the metal patch such that the microstrip antenna has a second resonant frequency different from the first resonant frequency. The microstrip antenna according to embodiments of the present disclosure has a wide bandwidth, a low profile, a high gain, a small size, and a simple structure.

### FIELD

The present disclosure generally relates to antennas, and more particularly, to a microstrip antenna, an antenna array and a method of manufacturing a microstrip antenna.

### BACKGROUND

Wideband low-profile microstrip antenna plays a key role for Multiple Input Multiple Output (MIMO) applications, especially the Massive MIMO in 5G where a large number of antenna elements are employed and each antenna element has a small occupying area and a wide bandwidth.

Microstrip antennas are lightweight, low profile and low cost devices typically with a cylindrical and conformal structure suitable for replacing bulky antennas. However, traditional microstrip antennas suffer from a narrow bandwidth and a wideband microstrip antenna usually has a high profile and uses air as the substrate thereby increasing the manufacturing complexity. Some of wideband microstrip antennas have a relatively large size due to loaded slots or have a relatively low gain. In short, existing wideband microstrip antennas have various defects in different aspects.

### SUMMARY

Embodiments of the present disclosure provide a microstrip antenna, an antenna array, and a method of manufacturing a microstrip antenna.

According to a first aspect of the present disclosure, a microstrip antenna is provided. The microstrip antenna includes a ground plane disposed on a first surface of a substrate of the microstrip antenna; a metal patch disposed on a second surface of the substrate opposite to the first surface; a feeding point disposed on the metal patch such that the microstrip antenna has a first resonant frequency; and a shorting point disposed on the metal patch such that the microstrip antenna has a second resonant frequency different from the first resonant frequency.

In some embodiments, an angle between a line from the shorting point to a center point of the metal patch and a line from the feeding point to the center point may be greater than 90 degrees and less than 180 degrees. In some embodiments, the shorting point may include a via connected to the ground plane.

In some embodiments, the microstrip antenna may further include at least one slot disposed around the feeding point. In some embodiments, the at least one slot may include two slots that are substantially symmetrical with respect to the line from the feeding point to the center point.

In some embodiments, the metal patch may include a circular metal patch. In some embodiments, the microstrip antenna may be fed via a coaxial cable.

In some embodiments, a thickness of the substrate may be smaller than about one tenth of a wavelength corresponding to a center frequency of the microstrip antenna. In some embodiments, a size of the metal patch may be smaller than about a half of a wavelength corresponding to the center frequency of the microstrip antenna.

According to a second aspect of the present disclosure, an antenna array is provided. The antenna array includes a plurality of microstrip antennas according to the first aspect of the present disclosure.

In some embodiments, an arrangement of the plurality of microstrip antennas and positions of the shorting points of the respective microstrip antennas on the respective metal patches may be disposed cooperatively, such that propagation of a surface wave in the antenna array is reduced. In some embodiments, the antenna array may be used in a multiple input multiple output (MIMO) system.

According to a third aspect of the present disclosure, a method of manufacturing a microstrip antenna is provided. The method includes providing a ground plane on a first surface of a substrate of the microstrip antenna; providing a metal patch on a second surface of the substrate opposite to the first surface; providing a feeding point on the metal patch, such that the microstrip antenna has a first resonant frequency; and providing a shorting point on the metal patch, such that the microstrip antenna has a second resonant frequency different from the first resonant frequency.

### BRIEF DESCRIPTION OF THE DRAWINGS

Through the following detailed description with reference to the accompanying drawings, the above and other objectives, features, and advantages of embodiments of the present disclosure will become more apparent. Several example embodiments of the present disclosure will be illustrated by way of example but not limitation in the drawings in which:

FIG. 1 schematically shows a structure diagram of a traditional microstrip antenna;

FIG. 2 schematically shows a structure diagram of another traditional microstrip antenna;

FIG. 3 schematically shows a structure diagram of a further traditional microstrip antenna;

FIG. 4 schematically shows a structure diagram of a still further traditional microstrip antenna;

FIG. 5 schematically shows a plan view of a microstrip antenna according to an embodiment of the present disclosure;

FIG. 6 schematically shows a side view of a microstrip antenna according to an embodiment of the present disclosure;

FIG. 7 schematically shows a graph of reflection coefficients of a microstrip antenna according to an embodiment of the present disclosure in the presence/absence of a shorting point;

FIG. 8 schematically shows a diagram of a radiation pattern of a microstrip antenna according to an embodiment of the present disclosure;

FIG. 9 schematically shows an antenna array according to an embodiment of the present disclosure;

FIG. 10 schematically shows a comparison graph of a correlation coefficient varying with the frequency for an antenna array according to an embodiment of the present disclosure and an antenna array formed by traditional microstrip antennas;

FIG. 11 schematically shows a diagram in which an antenna array according to an embodiment of the present disclosure can be mounted on a surface of a small base station; and

FIG. 12 schematically shows a flow chart of a method of manufacturing a microstrip antenna according to an embodiment of the present disclosure.

Throughout the drawings, same or similar reference numbers are used to represent same or similar elements.

### DETAILED DESCRIPTION OF EMBODIMENTS

Principles and spirits of the present disclosure will now be described with reference to various example embodiments illustrated in the drawings. It should be appreciated that description of those embodiments is merely to enable those skilled in the art to better understand and further implement example embodiments disclosed herein and is not intended for limiting the scope disclosed herein in any manner.

As mentioned above, microstrip antennas are lightweight, low profile and low cost devices with a cylindrical and conformal structure suitable for replacing bulky antennas. However, a microstrip antenna typically has an inherently narrow operating frequency bandwidth, for example, less than 5% of the center frequency, which limits more widespread usage of microstrip antennas.

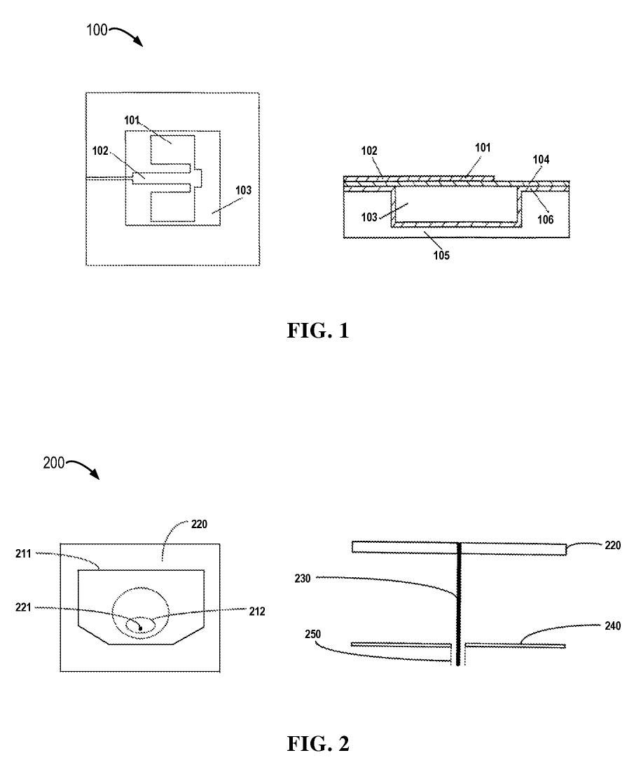

In traditional solutions, a way to extend the bandwidth of a microstrip antenna is increasing the thickness of the substrate with low effective permittivity. This traditional solution will be discussed below with reference to FIGS. 1 and 2.

FIG. 1 schematically shows a structure diagram of a traditional microstrip antenna 100. Specifically, the left figure is a plan view of the microstrip antenna 100 while the right figure is a sectional view of the microstrip antenna 100. As shown in FIG. 1, the microstrip antenna 100 may include a microstrip patch 101, a microstrip line 102, a back cavity 103, a microstrip dielectric plate 104, a structural support plate 105, and a metal ground 106.

FIG. 2 schematically shows a structure diagram of another traditional microstrip antenna 200. Specifically, the left figure is a plan view of the microstrip antenna 200 while the right figure is a sectional view of the microstrip antenna 200. As shown in FIG. 2, the microstrip antenna 200 may include a rectangular corner-truncated patch 211 with a hollow center portion, an elliptic patch 212, a feeding point 221, a dielectric plate 220, a coaxial probe 230, a ground plate 240, and a coaxial line feeding ground terminal 250.

It can be seen that the wideband microstrip antenna 100 in FIG. 1 extends the bandwidth by adding an air cavity 103, which will increase the thickness and manufacturing cost of the microstrip antenna 100. The microstrip antenna 200 in FIG. 2 simply increases the thickness of the microstrip antenna 200 and uses slots between the rectangular corner-truncated patch 211 and the elliptic patch 212 to cancel the inductance introduced by the long feeding probe 230. These methods in FIGS. 1 and 2 will lead to a high profile microstrip antenna and an increased manufacturing cost. In addition, the air cavity 103 may also limit the feeding network arrangement as it is on the back of the microstrip patch 101.

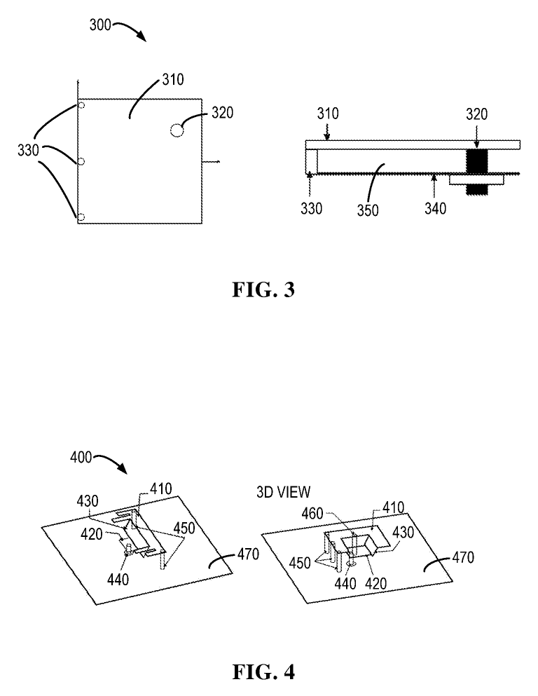

In traditional solutions, another solution of extending the bandwidth of the microstrip antenna is employing via loading or resistor loading. This traditional solution will be discussed below with reference to FIGS. 3 and 4.

FIG. 3 schematically shows a structure diagram of a further traditional microstrip antenna 300. Specifically, the left figure is a plan view of the microstrip antenna 300 while the right figure is a sectional view of the microstrip antenna 300. As shown in FIG. 3, the microstrip antenna 300 may include a square patch 310, a probe feeding 320, a short pin 330, a ground plane 340 and an air-filled substrate 350, etc.

FIG. 4 schematically shows a structure diagram of a still further traditional microstrip antenna 400. Specifically, the left figure is a plan view of the microstrip antenna 400 while the right figure is a three-dimensional (3D) view of the microstrip antenna 400. As shown in FIG. 4, the microstrip antenna 400 may include an upper patch 410, a lower patch 420, a folded slope-shaped portion 430, a probe feeding 440, a short pin 450, a center pin 460 and a ground plane 470, etc.

It can be seen that the via loading solution in the microstrip antennas 300 and 400 of FIGS. 3 and 4 uses several vias, which will reduce the antenna gain. Similarly, resistor loading can also increase the bandwidth, but it also decreases the radiation efficiency and antenna gain.

Additionally, in traditional solutions, slots can be also introduced into the radiator to increase the bandwidth of the microstrip antenna, for example, U-shape slots and rectangular slots. These slots usually increase the size of the antenna, but the bandwidth is significantly enhanced along with substrate thickness. Thus, this configuration also suffers from a high cost. Furthermore, the introduction of slots usually excites unnecessary surface waves and reduces performance of a microstrip antenna in a MIMO system. Because an antenna should be designed to be small for MIMO or massive MIMO application, a large size of each element will affect the antenna array arrangement. Although proximity feeding can increase the bandwidth for a relatively thin microstrip antenna, this arrangement is too complicated as it includes several layers.

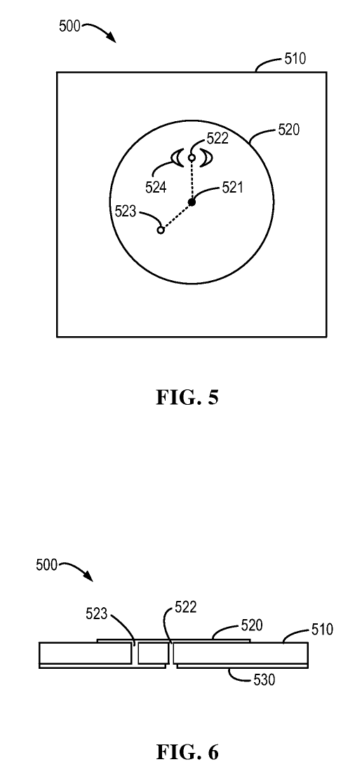

Therefore, the existing solutions cannot provide a low-cost microstrip antenna with a thin substrate, a wide bandwidth, a small size and a high gain. In view of this, embodiments of the present disclosure provide a microstrip antenna, which increases the bandwidth of a single-layer microstrip antenna without impacting the thickness, gain and patch geometry of the microstrip antenna. The arrangement of a feeding point and a shorting point probe enhances performance of the microstrip antenna in a MIMO system. The microstrip antenna according to the embodiments of the present disclosure has a low profile, a small size, a wide bandwidth and a high gain, and further it is simple in structure and effective in the cost. Thus, it can be widely used, for example, in MIMO system, especially in massive MIMO system in 5G communications. The structure of the microstrip antenna according to embodiments of the present disclosure will be described below in details with reference to FIGS. 5 and 6.

FIGS. 5 and 6 respectively show a plan view and a side view of a microstrip antenna 500 according to an embodiment of the present disclosure. As shown in FIGS. 5 and 6, the microstrip antenna 500 includes a substrate 510 fabricated by any dielectric materials suitable for the microstrip antenna. For example, in some embodiments, the substrate 510 may have permittivity of 2.55 and dielectric loss tangent of 0.0019. In some embodiments, the thickness of the substrate 510 may be smaller than about one tenth of a wavelength corresponding to the center frequency of the microstrip antenna 500, so as to achieve a low profile of the microstrip antenna 500. For instance, in case the operating frequency band of the microstrip antenna 500 is designed to cover 3.4-3.6 GHz of the long term evolution (LTE) band, the thickness of the substrate 510 may be approximately 3 mm. It is noted that the above described specific values are only examples and not intended to limit the scope of the present disclosure in any manner. Dependent on specific application environments and needs, any other appropriate values are viable.

Further, the microstrip antenna 500 also includes a ground plane 530 disposed on a first surface of the substrate 510. In FIG. 5, the first surface of the substrate 510 refers to a bottom surface of the substrate 510, which is not shown. In FIG. 6, the first surface of the substrate 510 is depicted as the bottom surface at the lower side of the substrate 510. Although FIG. 6 depicts the ground plane 530 as completely covering the first surface of the substrate 510, other covering manners are also possible. For example, the ground plane 530 covers only a portion of the first surface of the substrate 510 or forms a pattern, etc.

Additionally, the microstrip antenna 500 also includes a metal patch 520. As shown in the drawings, the metal patch 520 is disposed on a second surface of the substrate 510 opposite to the first surface. In FIG. 5, the second surface of the substrate 510 is shown as a top surface of the substrate 510. In FIG. 6, the second surface of the substrate 510 is depicted as a top surface at the upper side of the substrate 510. It should be understood that although the metal patch 520 is described as a circular metal patch in FIG. 5, technical solutions of the embodiments of the present disclosure are also applicable to metal patch 520 in other shapes, for example, rectangular metal patch, square metal patch and so on. In some embodiments, the metal patch 520 may be sized to be smaller than about a half of a wavelength corresponding to the center frequency of the microstrip antenna 500, such that the metal patch 520 will be more advantageous to be used in an antenna array arrangement of MIMO. For example, in case the operating frequency band of the microstrip antenna 500 is designed to cover the LTE band 3.4-3.6 GHz and the metal patch 520 is a circular metal patch, its radius can be 15 mm, that is 0.175 time of the wavelength at 3.5 GHz. Other center frequency values are also feasible and the scope of the present disclosure is not limited thereto.

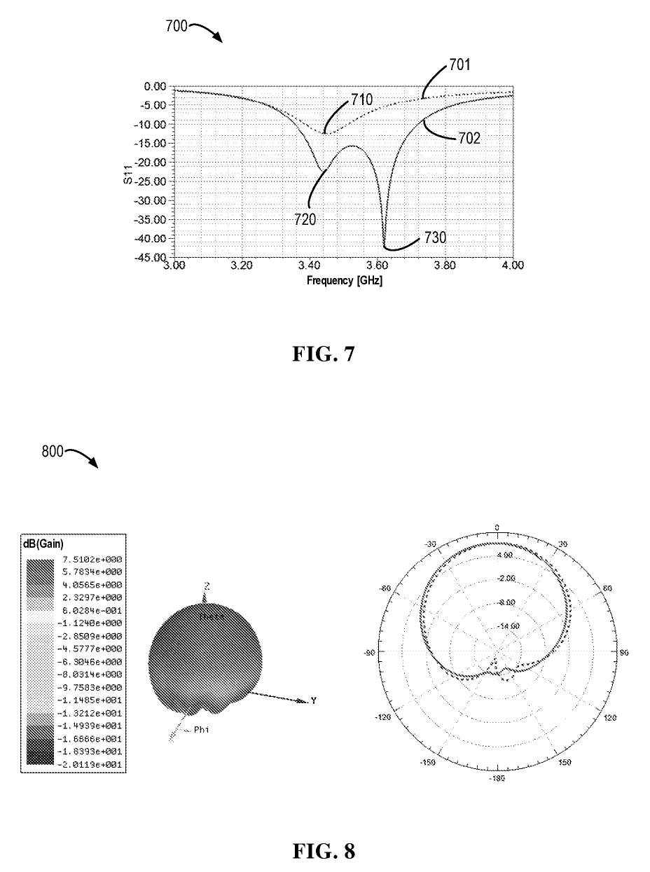

Moreover, the microstrip antenna 500 also includes a feeding point 522 arranged on the metal patch 520, such that the microstrip antenna 500 has a first resonant frequency. Further, the microstrip antenna 500 also includes a shorting point 523 that is also arranged on the metal patch 520, such that the microstrip antenna 500 has a second resonant frequency different from the first frequency. In embodiments of the present disclosure, the shorting point 523 may miniaturize the microstrip antenna 500 and the introduction of the shorting point 523 can also enable the microstrip antenna 500 to have a second resonant frequency different from the first resonant frequency. In this way, the operating bandwidth of the microstrip antenna 500 may be significantly extended without increasing the thickness of the microstrip antenna 500 or reducing the gain. The first resonant frequency and the second resonant frequency of the microstrip antenna 500 will be described below in details with reference to FIG. 7.

FIG. 7 schematically shows a graph 700 of reflection coefficients of a microstrip antenna 500 according to an embodiment of the present disclosure in the presence/absence of a shorting point 523. In the graph 700 of FIG. 7, the horizontal axis represents frequency in the unit of gigahertz (GHz) and the vertical axis represents the reflection coefficient S 11 in scattering parameters (S parameter) in the unit of decibel (dB). Furthermore, the dotted curve 701 represents the reflection coefficient curve of the microstrip antenna 500 without the shorting point 523, whereas the solid curve 702 indicates the reflection coefficient curve of the microstrip antenna 500 with the shorting point 523.

As shown in FIG. 7, the microstrip antenna 500 has only one resonant frequency 710 in the absence of the shorting point 523. In this event, the operating bandwidth of −10 dB is smaller than 4% of the center frequency in the specific example described by the graph 700. In contrast, the microstrip antenna 500 has two resonant frequencies in the presence of the shorting point 523, i.e., the first resonant frequency 720 and the second resonant frequency 730, and thereby the operating bandwidth is significantly extended. For example, in the specific example described by the graph 700, the operating bandwidth of −10 dB can be increased to about 3.35-3.73 GHz, that is approximate to 10.7% of the operating frequency, and the operating bandwidth of −15 dB can be increased to about 3.39-3.68 GHz, that is approximate to 8.2% of the operating frequency. In some embodiments, the reflection coefficient S11 of the microstrip antenna 500 may be adjusted by changing the position of the shorting point 523.

Returning to FIGS. 5 and 6, in some embodiments, an angle between a line from the shorting point 523 to a center point 521 of the metal patch 520 and a line from the feeding point 522 to the center point 521 can be greater than 90 degrees and less than 180 degrees. By implementing an angle of this range, the position relationship between the first resonant frequency 720 and the second resonant frequency 730 of the microstrip antenna 500 can be optimized, so as to increase the operating bandwidth of the microstrip antenna 500. In some embodiments, the angle can be approximately 135 degrees. It should be noted that the above value range or value of the angle is not requisite. In other embodiments, the microstrip antenna 500 can be implemented using other angles.

In case the operating frequency band of the microstrip antenna 500 is designed to cover the LTE band 3.4-3.6 GHz, the distance between the feeding point 522 and the center point 521 can be 7 mm. When a rectangular coordinate system is built in the plane of the patch 520 by taking the center point 521 as the origin and the line from the feeding point 522 to the center point 521 as a vertical axis, the shorting point 523 can be located at the coordinates (3.7 mm, −4 mm) and the radius of the shorting point 523 can be 0.5 mm.

Although the shorting point 523 in FIG. 6 is depicted as including a via 523 connected to the ground plane 530, embodiments of the present disclosure are not limited to this and other equivalent alternatives can also be employed to implement the shorting point 523. Furthermore, in some embodiments, the microstrip antenna 500 may be fed via a coaxial cable (not shown). For example, a 50Ω coaxial cable may be used to feed the microstrip antenna 500 on the second surface of the substrate 510. This feeding manner may be advantageous for microstrip antennas 500 forming an antenna array. In these embodiments, in order to feed the microstrip antenna 500, an inner conductor of the coaxial cable can be connected to the feeding point 522 while the outer conductor of the coaxial cable can be connected to the ground plane 530. However, embodiments of the present disclosure are not limited to this and other equivalent alternatives can also be used for feeding, for example, feeding through a microstrip line and so on.

Continuing to refer to FIG. 5, the microstrip antenna 500 may further include at least one slot 524. According to embodiments of the present disclosure, the at least one slot 524 can be arranged around the feeding point 522. The at least one slot 524 can facilitate the formation of the second resonant frequency of the microstrip antenna 500 and reduce propagation of surface waves in the antenna array in the scenario where the microstrip antenna 500 is used to form an antenna array. Besides, the at least one slot 524 may be used to compensate the probe inductance in the microstrip antenna 500 and can be disposed in a manner of reducing damage to the radiation currents as much as possible, so as to not influence the radiation efficiency of the microstrip antenna 500. In some embodiments, the at least one slot 524 may include two slots that are substantially symmetrical with respect to the line from the feeding point 522 to the center point 521. It should be noted that the slot 524 is not indispensable to the microstrip antenna 500 of embodiments of the present disclosure, and the microstrip antenna 500 may also be implemented without the slot 524.

FIG. 8 schematically shows a diagram 800 of a radiation pattern of the microstrip antenna according to an embodiment of the present disclosure. In the specific simulation process as depicted in FIG. 8, the operating frequency band of the microstrip antenna 500 is designed to cover the LTE band 3.4-3.6 GHz, the distance between the feeding point 522 and the center point 521 is 7 mm, the shorting point 523 is located at the coordinates (3.7 mm, −4 mm) in a rectangular coordinate system built in the plane of the patch 520 by taking the center point 521 as the origin and the line from the feeding point 522 to the center point 521 as a vertical axis, the radius of the shorting point 523 is 0.5 mm, and the substrate 510 has permittivity of 2.55, a dielectric loss tangent of 0.0019 and a thickness of 3 mm. As shown in FIG. 8, the simulation gain of the microstrip antenna 500 is 7.5 dB, which is substantially equivalent to a simulated gain of 7.6 dB for a traditional circular microstrip antenna having a narrow bandwidth. Additionally, the introduction of the shorting point 523 (for example, a shorting via) causes a slight asymmetry of the radiation pattern, and the bandwidth of 3 dB is from −45 degrees to −36 degrees. However, the impact on the performance of the microstrip antenna 500 is negligible.

Accordingly, the microstrip antenna 500 according to embodiments of the present disclosure achieves the advantages of a thin substrate, a wide bandwidth, a small size and low cost while realizing a high gain. The advantageous features make the microstrip antenna 500 particularly beneficial to form an antenna array in order to be used in a MIMO or massive MIMO application.

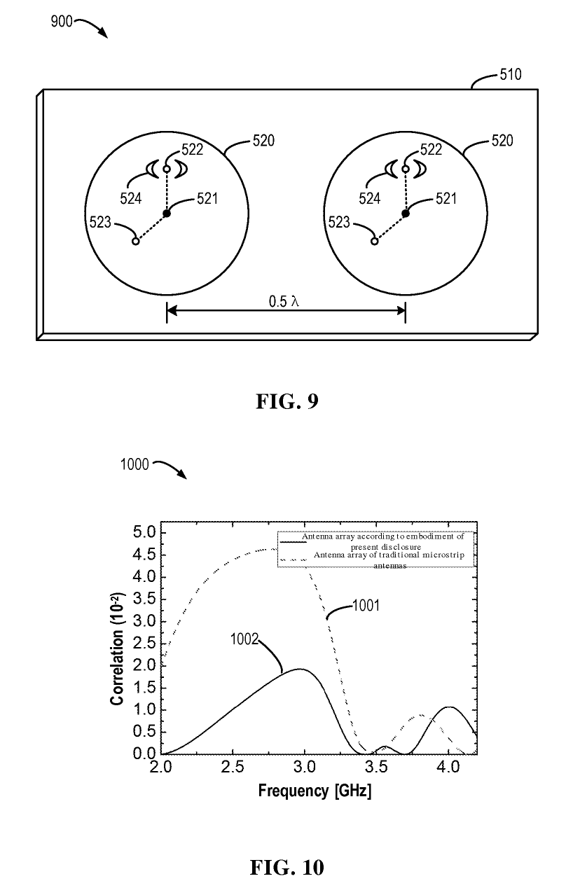

FIG. 9 schematically shows an antenna array 900 according to an embodiment of the present disclosure. As shown in FIG. 9, the antenna array 900 may include a plurality of microstrip antennas 500, each of which may include a common substrate 510 and respective metal patches 520. Although the antenna array 900 in FIG. 9 is depicted as including two microstrip antennas 500, the antenna array 900 can be formed by more microstrip antennas 500 in other embodiments. In addition, the antenna array 900 can be used in a multiple input multiple output MIMO system.

In some embodiments, the arrangement of the plurality of microstrip antennas 500 in the antenna array 900 and the positions of the shorting point 523 of the respective microstrip antennas 500 on the respective metal patches 520 can be cooperatively arranged, so as to reduce propagation of surface waves in the antenna array 900. In this way, the performance of the antenna array 900 may be further improved. For example, as shown in FIG. 9, the plurality of microstrip antennas 500 can be disposed side by side and the distance between each other can be configured as about a half of the wavelength of the center frequency of the microstrip antenna 500. Hereinafter, the performance advantages of the antenna array 900 according to embodiments of the present disclosure over an antenna array formed by traditional microstrip antennas will be described with reference to FIG. 10.

FIG. 10 schematically shows a comparison graph 1000 of a correlation coefficient varying with the frequency for the antenna array 900 according to an embodiment of the present disclosure and an antenna array formed by traditional microstrip antennas. In FIG. 10, S parameters are employed to calculate the correlation.

As shown in FIG. 10, the dotted curve 1001 represents a correlation curve between microstrip antennas in the antenna array formed by traditional microstrip antennas, while the solid curve 1002 represents a correlation curve between microstrip antennas 500 in the antenna array 900 formed by the microstrip antennas 500 according to embodiments of the present disclosure. It can be seen from FIG. 10 that the microstrip antennas 500 increase the bandwidth and maintain a very low correlation coefficient in the formed antenna array 900, and thus significantly improving the performance of the antenna array 900 compared with the traditional antenna array.

As mentioned above, the microstrip antenna 500 according to embodiments of the present disclosure has a wide bandwidth and can keep a very low correlation coefficient in the antenna array 900. The small size and low profile may enable the microstrip antenna 500 to be mounted on any surfaces, which makes a related product more attractive.

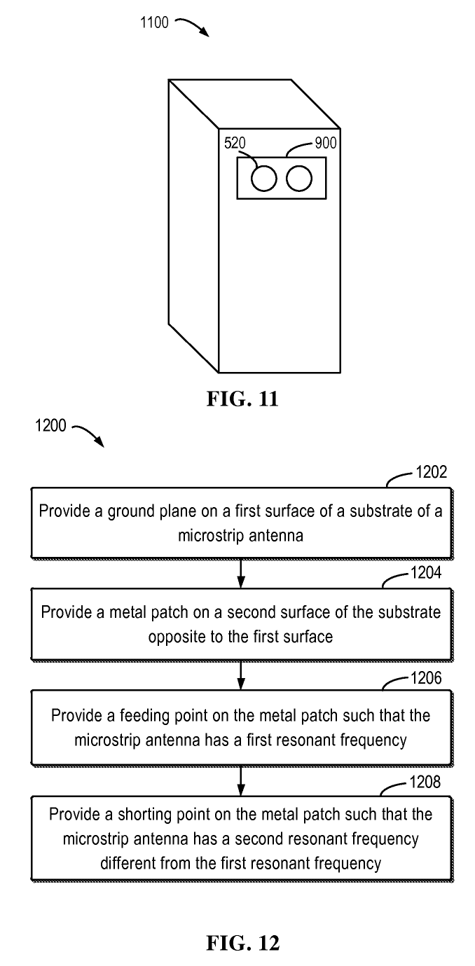

FIG. 11 schematically shows a diagram in which the antenna array 900 according to an embodiment of the present disclosure can be mounted on a surface of a small base station 1100. As shown in FIG. 11, the antenna array 900 including the patch 520 may be arranged on a surface of the small base station 1100. Such an arrangement can improve performance of a MIMO system. Additionally, the antenna array 900 may also be deployed around the small base station 1100 to realize a large range of coverage.

FIG. 12 schematically shows a flow chart of a method 1200 of manufacturing the microstrip antenna 500 according to embodiments of the present disclosure. As shown in FIG. 12, at 1202, a ground plane 530 is disposed on a first surface of a substrate 510 of the microstrip antenna 500. At 1204, a metal patch 520 is disposed on a second surface of the substrate 510 opposite to the first surface. At 1206, a feeding point 522 is disposed on the metal patch 520, such that the microstrip antenna 500 has a first resonant frequency. At 1208, a shorting point 523 is disposed on the metal patch 520, such that the microstrip antenna 500 has a second resonant frequency different from the first resonant frequency.

In some embodiments, providing the shorting point 523 on the metal patch 520 may include providing the shorting point 523 such that an angle between a line from the shorting point 523 to a center point 521 of the metal patch 520 and the line from the feeding point 522 to the center point 521 is greater than 90 degrees and less than 180 degrees.

In some embodiments, providing the shorting point 523 may include providing a via connected to the ground plane. In some embodiments, at least one slot 524 may be disposed around the feeding point 522. In some embodiments, providing the at least one slot 524 may include providing two slots that are substantially symmetrical with respect to the line from the feeding point 522 to the center point 521.

In some embodiments, the metal patch 520 may include a circular metal patch. In some embodiments, the microstrip antenna 500 may be fed via a coaxial cable. In some embodiments, the substrate 510 with a thickness smaller than about one tenth of a wavelength corresponding to the center frequency of the microstrip antenna 500 may be provided. In some embodiments, providing the metal patch 520 may include providing the metal patch 520 having a size smaller than about a half of the wavelength corresponding to the center frequency of the microstrip antenna 500.

Embodiments of the present disclosure provide a wideband microstrip antenna with a low profile, a high gain, a small size and a simple structure. The proposed microstrip antennas exhibit a wide bandwidth and a very low correlation coefficient in an antenna array. It can be used in the MIMO system of 5G and similar applications.

The microstrip antenna provided by the embodiments of the present disclosure achieves innovative improvements in the following five aspects. The first aspect is the thin substrate, which facilitates integration of the microstrip antenna with other circuits and reduces manufacturing cost. Then, the proposed microstrip antenna has a small size without compromising the gain, which provides a flexible arrangement in the MIMO system. Thirdly, the proposed microstrip antenna is single-layered and such a structure is simple and easy to make. Fourthly, the proposed microstrip antenna uses less via loading, which can be used to increase the operating bandwidth in the embodiments of the present disclosure. However, less via loading can reduce the manufacturing cost with less impact on the gain. Fifthly, the proposed microstirp antenna can radiate two orthogonal polarized waves simultaneously, which may reduce polarization mismatch in communications.

Compared with the traditional wideband microstrip antennas, the proposed microstrip antenna has several advantages. The proposed microstrip antenna has a rather low profile and the thickness of the antenna can be only 3 mm in practical use, which is approximate to 0.035 time of center frequency λ whereas most of traditional wideband microstrip antennas usually have a thickness of 0.1λ. The proposed microstrip antenna is single-layered, and the traditional single-layered wideband microstrip antennas typically have a high profile or complicated assembly due to the need for an air cavity, whereas the proposed antenna has the same simple structure as traditional narrow band microstrip antennas. The proposed microstrip antenna also has a small size and can be around 0.35 time of the center frequency wavelength λ in specific application scenario. In contrast, the existing wideband microstrip antennas using slots increases the size of the microstrip antenna. The small size enables the proposed antenna to have more choices in the MIMO antenna array arrangement. The proposed microstrip antenna has a low correlation coefficient in an antenna array, which will provide better MIMO performance. At last, the proposed microstrip antenna has a quite wide bandwidth compared with other traditional microstrip antennas with a low profile, a small size and a high gain.

In the description about embodiments of the present disclosure, the term “includes” and its variants are to be read as open-ended terms that mean “includes, but is not limited to.” The term “based on” is to be read as “based at least in part on.” The terms “one example embodiment” and “the example embodiment” are to be read as “at least one example embodiment.”

Although the present disclosure has been described with reference to several specific embodiments, it should be understood that the present disclosure is not limited to the specific embodiments disclosed herein. Particularly, the described contents of the present disclosure aim to encompass various modifications and equivalent arrangements included within the spirit and scope of the attached claims.

1. A microstrip antenna, comprising:
a ground plane disposed on a first surface of a substrate of the microstrip antenna;
a metal patch disposed on a second surface of the substrate opposite to the first surface;
a feeding point disposed on the metal patch such that the microstrip antenna has a first resonant frequency; and
a shorting point disposed on the metal patch such that the microstrip antenna has a second resonant frequency different from the first resonant frequency.

2. The microstrip antenna of claim 1, wherein an angle between a line from the shorting point to a center point of the metal patch and a line from the feeding point to the center point is greater than 90 degrees and less than 180 degrees.

3. The microstrip antenna of claim 1, wherein the shorting point includes a via connected to the ground plane.

4. The microstrip antenna of claim 1, further comprising:
at least one slot disposed around the feeding point.

5. The microstrip antenna of claim 4, wherein the at least one slot includes two slots that are substantially symmetrical with respect to a line from the feeding point to a center point of the metal patch.

6. The microstrip antenna of claim 1, wherein the metal patch includes a circular metal patch.

7. The microstrip antenna of claim 1, wherein the microstrip antenna is fed via a coaxial cable.

8. The microstrip antenna of claim 1, wherein a thickness of the substrate is smaller than about one tenth of a wavelength corresponding to a center frequency of the microstrip antenna.

9. The microstrip antenna of claim 1, wherein a size of the metal patch is smaller than about a half of a wavelength corresponding to a center frequency of the microstrip antenna.

10. An antenna array, including a plurality of microstrip antennas according to claim 1.

11. The antenna array of claim 10, wherein an arrangement of the plurality of microstrip antennas and positions of the shorting points of the respective microstrip antennas on the respective metal patches are disposed cooperatively, such that propagation of a surface wave in the antenna array is reduced.

12. The antenna array of claim 10, wherein the antenna array is used in a multiple input multiple output (MIMO) system.

13. A method of manufacturing a microstrip antenna, comprising:
providing a ground plane on a first surface of a substrate of the microstrip antenna;
providing a metal patch on a second surface of the substrate opposite to the first surface;
providing a feeding point on the metal patch such that the microstrip antenna has a first resonant frequency; and
providing a shorting point on the metal patch such that the microstrip antenna has a second resonant frequency different from the first resonant frequency.

14. The method of claim 13, wherein providing the shorting point on the metal patch comprises:
providing the shorting point such that an angle between a line from the shorting point to a center point of the metal patch and a line from the feeding point to the center point is greater than 90 degrees and less than 180 degrees.

15. (canceled)

16. The method of claim 13, further comprising:
providing at least one slot around the feeding point.

17.-21. (canceled)
